(19) United States
(12) Patent Application Publication
(10) Pub. No.: US 2017/0080357 A1
(43) Pub. Date: Mar. 23, 2017

(54) COLUMN TEMPERATURE COMPENSATION FOR CARBON DIOXIDE BASED CHROMATOGRAPHIC SYSTEM

(71) Applicant: Waters Technologies Corporation, Mitford, MA (US)

(72) Inventor: Joshua A. Shreve, Franklin, MA (US)

(73) Assignee: Waters Technologies Corporation, Milford, MA (US)

(21) Appl. No.: 15/310,537

(22) PCT Filed: May 12, 2015
(86) PCT No.: PCT/US15/30245

§ 371 Date: Nov. 11, 2016

Related U.S. Application Data
(60) Provisional application No. 61/991,802, filed on May 12, 2014.

(51) Int. Cl. B01D 15/16; G01N 30/30; G01N 30/32; B01D 15/40

(52) U.S. Cl. CPC B01D 15/161; B01D 15/40; B01D 15/163; G01N 30/30; G01N 30/32

(57) ABSTRACT

The present disclosure relates to controlling the average enthalpy of a mobile phase in a column that is part of a carbon dioxide based chromatographic system. By controlling average enthalpy, separations can be optimized, and method development and transfer between different carbon dioxide based separation systems can be more efficient.

### CROSS-REFERENCE TO RELATED APPLICATIONS

This application claims priority to U.S. Provisional Application No. 61/991,802 filed May 12, 2014, which is incorporated herein by reference in its entirety.

### FIELD OF THE TECHNOLOGY

The present disclosure relates to column temperature compensation for carbon dioxide based chromatographic systems. Column temperature in carbon dioxide based chromatographic systems can vary as a result of different factors, including carbon dioxide expansion and frictional heating. The present disclosure relates to methodologies and apparatus for compensating for these variations.

### BACKGROUND

The major parameters affecting carbon dioxide based chromatographic separations include temperature (e.g., column temperature, mobile phase temperature, detector temperature), pressure and flow rate. These parameters are typically pre-set and controlled during carbon dioxide based separations. For example, one or more of these parameters may be held constant over the course of a separation (i.e., isothermal) or may be changed (i.e., temperature gradient) to effect a desired separation or retention. These parameters are often monitored or controlled by sensors placed throughout the carbon dioxide based chromatographic system (e.g., pressure sensor at the pump) or by equipment designed to achieve a pre-set value (e.g., external column heater setting or pump flow rate setting).

Variations in one or more of these parameters can be detrimental to the desired separation. For example, a change in pressure or temperature can affect the solubility of a target compound(s) in a carbon dioxide based chromatographic system. The solubility of a component in carbon dioxide can be affected by the vapor pressure of the component and its interaction with the carbon dioxide. The influence of these parameters on solubility in carbon dioxide is determined by the properties of the solute and the carbon dioxide as well as by the experimental temperature and pressure conditions. Temperature variations can also induce changes in the vapor pressure of the solute, the density of the carbon dioxide and the physicochemical properties of both the solute and the carbon dioxide. Additional controls of these parameters in carbon dioxide based chromatographic systems would be beneficial.

### SUMMARY

The present disclosure relates to column temperature compensation for carbon dioxide based chromatographic systems.

In one embodiment, the present disclosure relates to a method of optimizing a separation in a carbon dioxide based chromatographic system having a pump, a carbon dioxide based mobile phase, a chromatographic column downstream of the pump, and a detector downstream of the column, wherein the column has an inlet and an outlet, the method comprising (i) measuring an inlet pressure and an inlet temperature of a mobile phase entering the column inlet and an outlet pressure of the mobile phase exiting the column outlet, (ii) calculating an average enthalpy of the mobile phase in the column, (iii) comparing the average enthalpy with a desired enthalpy value, (iv) adjusting the inlet pressure of the mobile phase entering the column inlet, the inlet temperature of the mobile phase entering the column inlet, or a combination of both to obtain the desired enthalpy value.

In another embodiment, the present disclosure relates to a method of efficiently transferring a carbon dioxide based separation between at least two different carbon dioxide based separation systems comprising (i) determining an average mobile phase enthalpy for a first compressed fluid separation on a first carbon dioxide based separation system; and (ii) performing a second carbon dioxide based separation on the second compressed fluid separation system at the average mobile phase enthalpy.

In another embodiment, the present disclosure relates to a method of transferring a carbon dioxide based separation procedure from a first system to a second system without re-optimizing the separation procedure conditions of the second system, comprising operating both systems at the same average mobile phase enthalpy value.

The present disclosure provides a number of advantages over current methods and apparatus. For instance, separation reproducibility, retention time variability and critical pair resolution can be negatively affected by column temperature variations, including local or temporal variations, in the column during a separation. The disclosed methodology can be used to minimize or compensate for these variations. As a result, separation performance is improved including run to run reproducibility, retention time variability and critical pair resolution. In addition, methods can be more efficiently transferred between systems of micro, analytical and preparatory scale. Many parameters (e.g., temperature, pressure and flow rate) do not necessary scale directly with the transfer between systems. For example, when changing flow rates between systems a change in the pressure drop across the column changes the effective average temperature in the column. The present methodology can account for these changes and provide more consistent separation behavior at a much wider range of flow rates and system configurations.

### BRIEF DESCRIPTION OF THE FIGURES

The foregoing and other features and advantages provided by the present disclosure will be more fully understood from the following description of exemplary embodiments when read together with the accompanying drawings, in which:

FIG. 1 shows an exemplary flowchart regarding the optimization of a separation in a carbon dioxide based chromatography system having a pump, a column and a detector.

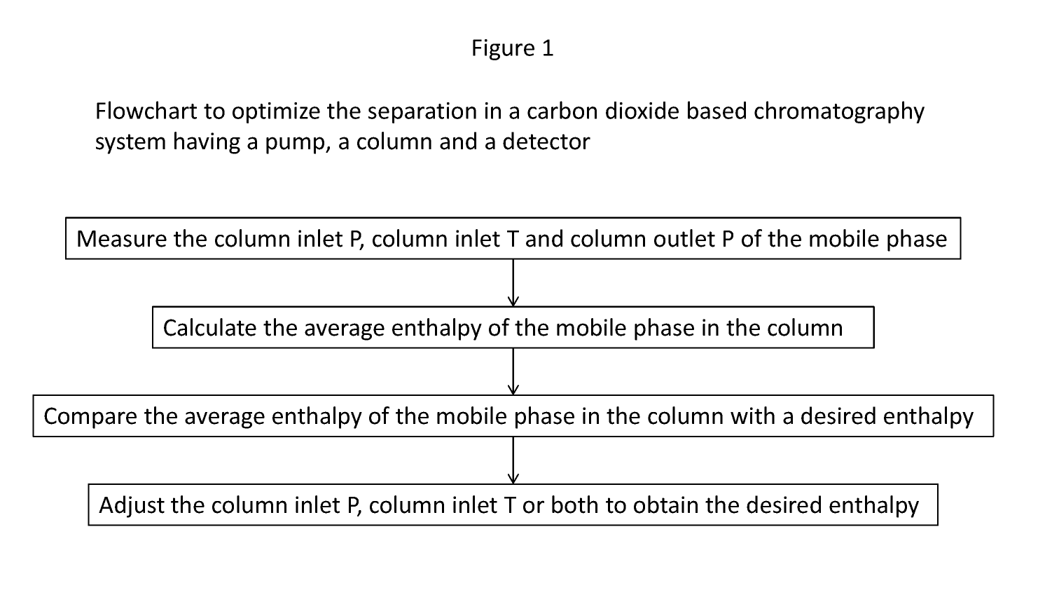

FIG. 2 shows an exemplary flowchart regarding efficient transfer of a carbon dioxide based separation between two different carbon dioxide based separation systems.

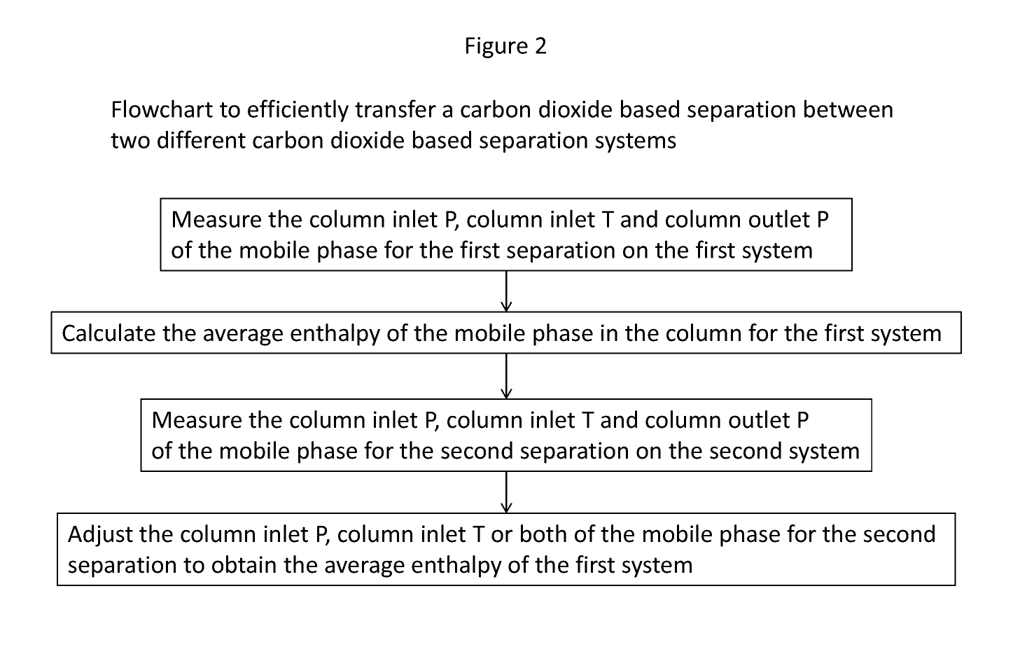

### DETAILED DESCRIPTION

The present disclosure relates to column temperature compensation for carbon dioxide based chromatographic systems.

The methodology of the present disclosure can be used to adjust the temperature control of the solvent, column or both in a chromatographic system to account for physical effects that occur in the system, or between systems. Two of these physical effects which impact the column temperature are carbon dioxide expansion cooling and frictional heating. As described in the present disclosure, the impact of these effects on column temperature can be calculated and compensated for.

For column temperature compensation in carbon dioxide based chromatographic systems, different methods can exist. One method involves direct measurement of the mobile phase temperature at the column inlet and outlet. The average of these temperatures can be calculated and controlled. This method requires, however, additional hardware not included on standard carbon dioxide based chromatographic systems to perform the direct measurement at both the column inlet and outlet.

Another method involves calculating the energy associated with the heating and cooling of the column and, using known solvent characteristics, adjusting the column temperature heater to target an average pre-determined temperature, or other pre-determined elution properties. This method requires accurate input regarding known solvent characteristics.

The methodology of the present disclosure compensates for variations in column temperature due to such factors as expansion and frictional heating. The variations are compensated for by calculating the energy associated with the heating and cooling of the column, and increasing or decreasing the power to a column heater to compensate for the calculated change. This method uses the knowledge of the system to calculate the correct amount of energy to add/remove from the system to compensate for the physical phenomena.

One objective of the present disclosure is to achieve average retention properties equivalent to the retentive properties at the setpoint column pressure and temperature. Another objective is to have reproducible retention properties for a setpoint temperature and pressure on all scale systems (micro, analytical, preparative, etc.). In carbon dioxide based chromatographic systems the pressure varies primarily due to restriction or friction, and the temperature varies primarily due to both friction heating and expansion cooling. The expansion cooling is theoretically isenthalpic.

Properties of interest in column temperature compensation for carbon dioxide based chromatographic systems include density, enthalpy, pressure and temperature. Both density and enthalpy have strong primary relationships to analyte retention. Pressure and temperature have strong secondary relationships to analyte retention due to their effect on density and enthalpy. Pressure and temperature also have other secondary effects on the chromatographic system not related to density and enthalpy depending on the chemistry used in the separation.

Specific enthalpy (h), or enthalpy per unit mass, is a property calculated as the function of pressure and temperature. Enthalpy can be one of the most direct calculations to determine the energy and power values. Indirect calculations using, for example, average density or specific gravity (inverse of density) are also possible. These calculations, however, are more convoluted as density is not an energy base property like enthalpy.

Pressure and temperature are two variables that can be directly controlled. By controlling both pressure and temperature, other parameters can be controlled. Typically, chromatographic systems users control and set the temperature and pressure. Direct control by setting the density or enthalpy of a carbon dioxide based chromatographic system is not available.

As used herein the following terms are defined:

P₁=Pressure at the beginning of the column.

P₂=Pressure at the end of the column.

T₁=Temperature at the beginning of the column.

T₂=Temperature at the end of the column.

h(P,T)=Specific Enthalpy as a function of pressure and temperature.

rho, ρ=Density

H=Enthalpy.

M=Mass flow.

V=Volumetric Flow.

Q=Heat transfer in Watts.

q=Specific Heat transfer in Watt*m³/kg.

Xₛₑₜₚ=User set parameter.

Tₛₑₜₚ=User set temperature of the column.

Pₛₑₜₚ=User set pressure of the column. One embodiment of the present disclosure uses average column pressure and described in U.S. Provisional Application Ser. No. 61/864,856, titled “Mobile phase controller for supercritical fluid chromatography systems, filed Aug. 12, 2013, the disclosure of which is incorporated herein by reference in its entirety. For example, the average mobile phase column pressure can be the average mobile phase pressure calculated from (i) the inlet mobile phase pressure measured at the head of the column and (ii) the output mobile phase pressure measured at the base of the column. In another example, the average mobile phase column pressure is the average mobile phase pressure calculated from (i) the mobile phase pressure measured at the output of the pump and (ii) the mobile phase pressure measured at the ABPR inlet. Combinations of these embodiments may also be used to determine the average mobile phase.

Xₘ=Measured data, ex. T₁ₘ.

X_{c}=Calculated data, ex. T_{2c}.

The present disclosure relates to controlling the average enthalpy in the column either set directly by a user or calculated from the properties at the user setpoint temperature and pressure. As shown below, specific enthalpy is a function of pressure and temperature.

h_{target}=h(Pₛₑₜₚ, Tₛₑₜₚ) (eq. 1)

In other applications, density can also be controlled. Density is also a function of pressure and temperature.

ρ_{target}=ρ(Pₛₑₜₚ, Tₛₑₜₚ) (eq. 2)

In one embodiment, the chromatographic system achieves the average enthalpy with respect to the time spent in the column by the mobile phase. The full mathematical calculation model requires accurate measurement of the system parameters and knowledge of the system parameters. An example equation is shown below. The model can be a closed from equation or a discrete computational model.

$$\frac{{\int }_{{t}_{i}}^{{t}_{f}} h ( P ( t ) , T ( t ) d t}{{t}_{f} - {t}_{i}} = {h}_{target} \qquad ( eq . 3 )$$

A simplified model can assume an average mobile phase velocity and consider the spacial average. This simplified model is slightly less complex but has comparable requirements to the previous model. A simplified equation is shown below.

$$\frac{{\int }_{{x}_{i}}^{{x}_{f}} h ( P ( x ) , T ( x ) ) d x}{{x}_{f} - {x}_{i}} = {h}_{target} \qquad ( eq . 4 )$$

The mathematical calculation can be further simplified by assuming a linear trend which allows for the removal of the integral and the use of a two point average. This version of the model allows for simpler calculations that can be done in the time frame of a chromatographic separation. The equation is shown below.

$$\frac{h ( P ( {x}_{2} ) , T ( {x}_{2} ) ) + h ( P ( {x}_{1} ) , T ( {x}_{1} ) )}{2} = \frac{h ( {P}_{2} , {T}_{2} ) + h ( {P}_{1} , {T}_{1} )}{2} = {h}_{target} \qquad ( eq . 5 )$$

The mathematical models described above relate to a 100% carbon dioxide mobile phase. In carbon dioxide based chromatographic separations a cosolvent is often used (e.g., methanol). In most circumstances the properties of the cosolvent, and thus uniform mobile phase, are not known or available. The presence of a cosolvent makes the direct use of enthalpy or density as a controlled/controllable variable difficult. Without the cosolvent information, the enthalpy and density of the mobile phase mixture cannot be calculated using temperature and pressure. The two point average approach is an excellent first order correction, as would be the model integration or discretization approaches.

The model integration approach uses a thermodynamic model to calculate the properties along the length of the column with a closed form solution. A discretization approach calculates the properties in sections. As the pressure and temperature change through the column the new calculated properties (enthalpy, density, viscosity, etc.) are recalculated based on the temperature and pressure change caused by the previous section calculation. This creates simple calculations and uses additional computing. The closed form solutions are typically challenging to derive and often need to be re-derived if any characteristics of the system change. The discretized models use many simple calculations to approximate a single more complex solution and are more flexible due to their ability to accommodate nonlinearities.

Based on the common control points and sensors in a carbon dioxide based chromatographic system or a supercritical fluid chromatographic (SFC) system, the average pressure is the most direct value to use as the first controlled variable. For temperature, a slightly more accurate model is to use the enthalpy of the carbon dioxide and the viscous heating of the mixture to estimate the required energy to average out the enthalpy of the inlet and outlet to be equivalent to the target. This assumes no effect of the decompression of the cosolvent, which is consistent with the basic assumptions in liquid chromatography. In one embodiment, an efficient form of this calculation can be based on sensors in a typical system to determine the energy difference between the standard setpoint and the setpoint that will give approximately the average enthalpy. For this embodiment, the average temperature and pressure are controlled.

In general, once the average energy change is determined the energy can be adjusted back. The change in setpoints (e.g., pressure and temperature) to adjust for the change in energy can be handled many ways. If the fluid and cosolvent composition and properties are known, then the temperature setpoint can be changed to achieve the desire enthalpy at the inlet by either calculating or measuring the properties at the inlet and outlet. Alternatively, the energy can be added directly if the fluid heating device is characterized, such that there is a clear model or correlation between temperature and power normalized to the dynamically measured conditions. If so, by changing the setpoint to add the requisite power based on the characterization equations the energy can be directly added to the system. This can be done with the temperature and power measurements of the heating device. For example, the passive losses of the system are linear with temperature:

$${Q}_{passive} = \frac{1}{{R}_{loss}} \cdot ( {T}_{setp} - {T}_{amb} ) \qquad ( eq . 6 )$$

The fluid heat load is proportional to the temperature setpoint, but can dynamically change.

$$\begin{matrix}{Q}_{fluid} = \frac{1}{{R}_{fluid}} \cdot ( {T}_{setp} - {T}_{amb} ) & ( eq . 7 ) \\ {Q}_{heater} = ( \frac{1}{{R}_{loss}} + \frac{1}{{R}_{fluid}} ) \cdot ( {T}_{setup} - {T}_{amb} ) & ( eq . 8 )\end{matrix}$$

R can be dynamically calculated as follows:

$$\frac{1}{{R}_{sys}} = \frac{{Q}_{heater}}{( {T}_{setp} - {T}_{amb} )} = \frac{Q}{Δ T} \qquad ( eq . 9 )$$

Rₗₒₛₛ can be obtained by characterizing the system with no flow. Thereafter, the temperature setpoint to add power to the user defined setpoint can be calculated.

Tₛₑₜₚ₂=Tₛₑₜₚ+(R_{sys}−Rₗₒₛₛ)ΔQ (eq. 10)

The above example is the simplest approximation of the present disclosure. More complex thermal systems may require more complex characterizations, but the process is the same. The above example is applicable for mobile phase mixtures. Even though some of the heat will be absorbed by the cosolvent, some of the cooling affect will also be mitigated by the cosolvent. In one embodiment, the two effects balance leaving the desired effect intact even at higher cosolvent compositions.

In some embodiments, the carbon dioxide expansion energy change can be calculated using the inlet temperature, the pressure drop through the column and the flow rate. The inlet pressure can be the pump pressure measured before the column, and the outlet pressure (to determine the pressure drop) can be the ABPR pressure measured after the column. Additional pressure transducers can be placed before and after the column to more accurately record these values (e.g., immediately before and/or immediately after the column openings). The mobile phase frictional heating change can be calculated using the pressure drop multiplied by the volumetric flow rate of the mobile phase through the column. In some embodiments, the methodology of the present disclosure can be applied to any chromatographic system. For example, the disclosure related to frictional heating adjustment can be applied to HPLC. The frictional heating calculation and the energy addition through the system characterization can be applied to any chromatographic system without requiring knowledge of the mobile phase.

The calculations set forth in the present disclosure can be used to calculate the energy associated with the heating and cooling of the column, and the power needed to compensate for the increase or decrease associated with the calculated change.

For carbon dioxide based chromatographic system that have no additional sensors, the following equations can be used. The enthalpy of the inlet and enthalpy of the outlet can be calculated with the target temperature and the measured pressures. Since the temperature is not measured at the outlet, the enthalpy of the desired temperature at the outlet pressure is calculated, given P₁, P₂, T₁, and Tₛₑₜₚ.

h_{1c}=h(P1ₘ, Tₛₑₜₚ) (eq. 11)

h_{2c}=h(P2ₘ, Tₛₑₜₚ) (eq. 12)

The objective is to add half the power difference to the input. The specific cooling energy is calculated as follows:

qc=V((h2−h1)/2) (eq. 13)

The cooling energy is calculated as follows:

Qc=M((h2−h1)/2)=ρV((h2−h1)/2) (eq. 14)

In contrast, for a carbon dioxide based chromatographic system having additional sensors, the following methodology can be used. The input temperature can be adjusted until the average of the input and output temperatures match the setpoint. In these systems, enthalpy could also be averaged. The properties of the co solvent, if any, can be included in the calculation. For these measurement based approaches, density can be used to replace enthalpy. Using methods that maintain an average density can be used. In general, changes in specific gravity (the inverse of density) and enthalpy track each other. For example, given P₁, P₂, T₁, T₂, and Tₛₑₜₚ.

$${T}_{setp} = \frac{{T}_{2 m} + {T}_{1 m}}{2} \qquad ( eq . 15 )$$

The equation below could be used as a feedback controller.

T₁ₘ=2 Tₛₑₜₚ−T₂ₘ (eq. 16)

If including solvent properties in the calculation, the follow equations apply.

h1c=h(P1ₘ, T1ₘ) (eq. 17)

h2c=h(P2ₘ, T2ₘ) (eq. 18)

The equation below would be the controller objective for a feedback controller.

h_{target}=h(P_{avg}, T_{avg})=(h_{1c}+h_{2c})/2 (eq. 19)

Additional energy from frictional or restrictive heating can also be calculated from the volumetric flow rate at the pump (V) and the pressure drop through the column(delta P). Q_{f} is friction heating power.

Q_{f}=Vₚᵤₘₚ·(P₂ₘ−P₁ₘ) (eq. 20)

The volumetric flow can be obtained from the pump flow rates. In the case of carbon dioxide, an adjustment for density change can be made to make the calculation more accurate. Co-solvents are relatively incompressible though adjustments could be made if the solvent is known. The following calculation adjusts for density change. Average values are used as an approximation for more complex integrals or multiple finite element calculations of properties through the column.

ρₚᵤₘₚ=ρ(Tₚᵤₘₚ, Pₚᵤₘₚ) (eq. 21)

ρ_{col}_{_}_{avg}=ρ(T_{col}_{_}_{avg}, P_{col}_{_}_{avg}) (eq. 22)

Q_{f}=Vₚᵤₘₚ(ρₚᵤₘₚ/ρ_{col})(P2−P1) (eq. 23)

The additional energy, or power, can be calculated as a target h1. The measurements used to calculate h1 (e.g., temperature and pressure) are used in the energy calculations. These calculations are not a closed form solution as the measurements will vary over time. A controller can be used to implement the equations. The setpoint can be adjusted to maintain the desired conditions. This can be done by PID or by iterative recalculation depending on the stability of the system. In one embodiment, the iterative calculation is preferred. The calculation can be complex. In some embodiments, the calculation cycle time can be longer than a typical PID controller. The following equation can be used.

$$H {1}_{target} = H 1 + \frac{( {Q}_{c} - {Q}_{f} )}{2} \qquad ( eq . 24 )$$

Alternatively, the direct form of the equation can be used.

h1_{target}=h(P1ₘ, Tsetp)+((h(P2ₘ, Tsetp)−h(P1ₘ, Tsetp))/2) (eq. 25)

T1_{target}=T(h1_{target}, P1ₘ) (eq. 26)

In another embodiment, the h1_{target} can be used for a reverse lookup to calculate a temperature setpoint based on the measured pressure at the column inlet. For higher compositions of cosolvent properties of the mixture can be required. For low cosolvent compositions the carbon dioxide can be assumed to be dominant or an average cosolvent behaviors can be used. As such, the present methodology can be applied to linear or gradient mobile phase programs.

The present methodology can be applicable to micro, analytical and preparative carbon dioxide based chromatographic systems. The present methodology can also be applied to other compressible fluid systems which may or may not comprise carbon dioxide. The present disclosure is applicable to chromatographic systems that employ a mobile phase or mobile phase compliment that is compliant in liquid form (i.e., the mobile phase or component can absorb/expand in the liquid form). In some applications, the present methodology can be used in liquid chromatography to lower the APH heat input to account for frictional heating in the column.

In some embodiments, the inlet pressure can be adjusted to obtain the desired enthalpy value. In other embodiments, the inlet temperature is adjusted to obtain the desired enthalpy value. In still other embodiments, the inlet temperature is adjusted by a mobile phase pre-column heater to obtain the desired enthalpy value.

Another method of the present disclosure involves using the assumption of isenthalpic cooling. When using this assumption, T2 is calculated based on T1 and P1. Then, the input temperature or energy is raised half of the difference.

$$\begin{matrix}{T}_{2 c} = T ( {h}_{1} ( {T}_{setp} , {P}_{1 m} ) , {P}_{2 m} ) & ( eq . 27 ) \\ {T}_{1 c} = \frac{{T}_{2 c} + {T}_{setp}}{2} & ( eq . 28 ) \\ {Q}_{c} = h ( {T}_{1 c} , {P}_{1 m} ) - h ( {T}_{setp} , {P}_{1 m} ) & ( eq . 29 )\end{matrix}$$

The pressure drop can cause an isenthalpic expansion. The temperature drops as well to maintain the same enthalpy, h2=h1. The calculation of enthalpy at the beginning and the end of the column based on the temperature setpoint can be an estimate of the energy difference from ideal.

h₁=h(Tₛₑₜₚ, P₁) (eq. 30)

h₂=h(Tₛₑₜₚ, P₂) (eq. 31)

In one embodiment, T₁ and T₂ are difference values and h₂ is equal, or substantially equal, to h₁ with no cosolvent, e.g, 100% carbon dioxide. By calculating the ideal h₂, the difference in energy on the outlet between the actual and desired is determined. By adding half of the difference to the inlet, the energy difference from ideal is split at the inlet and outlet to substantially center the average temperature to the setpoint value.

$${T}_{1} = T ( \frac{{h}_{2} + {h}_{1}}{2} , {P}_{1} ) \qquad ( eq . 32 )$$

In one embodiment, the present disclosure relates to a method of optimizing a separation in a carbon dioxide based chromatographic system having a pump, a carbon dioxide based mobile phase, a chromatographic column downstream of the pump, and a detector downstream of the column, wherein the column has an inlet and an outlet, the method including measuring an inlet pressure and an inlet temperature of a mobile phase entering the column inlet and an outlet pressure of the mobile phase exiting the column outlet; calculating an average enthalpy of the mobile phase in the column; comparing the average enthalpy with a desired enthalpy value; adjusting the inlet pressure of the mobile phase entering the column inlet, the inlet temperature of the mobile phase entering the column inlet, or a combination of both to obtain the desired enthalpy value. The methodology of the present disclosure can be compatible with any CO₂-based chromatography system including a pump, column, detector, heaters/coolers and sufficient measurement devices. An example of a CO2-based chromatography system is the analytical equipment available from Waters Corporation, Milford, Mass., USA, sold in connection with the mark ACQUITY UPC2®.

The desired enthalpy value can be based on the solvents being used and the setpoint temperature and pressure. In some embodiments, the methodology measures the system values and characteristics, and applies a correction without specific knowledge of a pre-determined enthalpy. The enthalpy loss can be measured and half of lost enthalpy can be added back.

The present disclosure is applicable to mobile phases having 100% carbon dioxide or other compressible fluids, and mobile phases having up to 50% co-solvents, such as methanol. In particular, the mobile phase can have up to 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% one or more co-solvents. These values can be used to define a range, such as about 1% to about 10%.

The difference between the average enthalpy of the mobile phase and the desired enthalpy value can be less than about 20%, 19%, 18%, 17%, 16%, 15%, 14%, 13%, 12%, 11%, 10%, 9%, 8%, 7%, 6%, 5%, 4%, 3%, 2%, or about 1%. These values can be used to define a range, such as about 2% to about 5%. the difference

In another embodiment, the present disclosure relates to a method of efficiently transferring a carbon dioxide based separation between at least two different carbon dioxide based separation systems comprising determining an average mobile phase enthalpy for a first carbon dioxide based separation on a first carbon dioxide based separation system, and performing a second carbon dioxide based separation on the second carbon dioxide based separation system at the average mobile phase enthalpy. The difference between the average mobile phase enthalpy of the first separation and the second separation where the second separation is performed can be less than about 20%, 19%, 18%, 17%, 16%, 15%, 14%, 13%, 12%, 11%, 10%, 9%, 8%, 7%, 6%, 5%, 4%, 3%, 2%, or about 1%. These values can be used to define a range, such as about 2% to about 5%. the difference The first separation system and the second separation system can include separation columns having similar stationary phases.

The first column can have at least one column dimension that is different from the second column. These column dimensions can include column length, column inner diameter, shape or size of the packing material (e.g., particle size), porosity of packing material, and similar characteristics, and combinations thereof. For example, the first and second columns may have different particle sizes (e.g., 1.7 μm versus 5.0 μm).

One measure of evaluating the efficient transfer of the separation between the first and second carbon dioxide based separation systems can be wherein the second carbon dioxide based separation performed on the second system exhibits substantially the same retention factor (k′) or selectivity as the first carbon dioxide based separation on the first system. The difference between the retention factor or selectivity of a first separation, a first peak or peaks in a first separation and a second separation, a second peak or peaks in a second separation can be less than about 20%, 19%, 18%, 17%, 16%, 15%, 14%, 13%, 12%, 11%, 10%, 9%, 8%, 7%, 6%, 5%, 4%, 3%, 2%, or about 1%. These values can be used to define a range, such as about 2% to about 5%.

In another embodiment, the present disclosure relates to a method of transferring a carbon dioxide based separation procedure from a first system to a second system without re-optimizing the separation procedure conditions of the second system, comprising operating both systems at the same average mobile phase enthalpy value. By eliminating or reducing the need to re-optimize, the need to perform and monitor multiple chromatographic separations at various conditions (e.g., temperatures) to evaluate the difference in chromatographic performance (e.g., retention time) due to thermal column effects. In one aspect, the manually adjustments a user would need to perform can be done automatically.

In U.S. Provisional Application Ser. No. 61/864,856 the benefits and methods of pressure and density control are disclosed. The application discloses control of either average pressure or density by means of modifying pressure. In different embodiments, the present disclosure relates to temperature and/or pressure, and enthalpy control. Another aspect of the present disclosure relates to methodology of controlling both density and enthalpy. The control of both density and enthalpy can produce repeatable and scalable methods. In a particular embodiment, pressure can be used to directly control the average density or approximately control the average density by controlling average pressure, and the temperature can be used to directly control the average enthalpy or approximately control the average enthalpy by controlling the average temperature.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

### EXAMPLES

### Example 1

A carbon dioxide based separation is transferred between two different analytical scale carbon dioxide based separation systems using the temperature compensation methodology of the present disclosure. A test solution comprising multiple compounds is separated on a first analytical scale carbon dioxide based system. The test solution is then separated on a second analytical scale carbon dioxide based system having a chromatographic column with at least one different physical dimension (e.g., internal diameter, column length, etc.). The methodology of the present disclosure is used to efficiently transfer the separation between systems to obtain substantially similar separation performance (e.g., resolution and/or retention of the test solution components).

The first analytical scale carbon dioxide based system consists of an analytical scale carbon dioxide based chromatography instrument using an Ethylene Bridged Hybrid (“BEH” for short) 2-EP column (2.1×150 mm, 5 μm particle size), available at Waters Corporation (Milford, Mass.). The particle size of the first column is 1.7 μm. The separation is isocratic using a carbon dioxide mobile phase with 10% methanol modifier and performed at a flow rate of 1.5 mL/min and at 40° C. The test solution components are separated and exhibit the a first set of performance characteristics (e.g., capacity factor, resolution, retention time, etc.).

The second analytical scale carbon dioxide based system consists of an analytical scale carbon dioxide based chromatography instrument using a BEH 2-EP column (2.1×150 mm, 5 μm particle size), available at Waters Corporation (Milford, Mass.). The particle size of the second column is 5.0 μm, as opposed to 1.7 μm. The separation is isocratic using a carbon dioxide mobile phase with 10% methanol modifier and performed at a flow rate of 1.5 mL/min and at 40° C.

The following parameters from the first system are determined, e.g., P1, P2, T2, etc. The pressure values for P1 and P2, individually, can be greater than about 1000, 1500, 2000, 2500, 3000, 3500, 4000, 4500, 5000, 5500, 6000, 6500, 7000, 7500, 8000, 8500, 9000, 9500 or about 10,000 psi. These values can also be used to define a range, such as for P1 of about 3000 to about 6000 psi, and for P2 of about 1500 to about 3000 psi. The difference between P1 and P2 can be greater than about 10, 50, 100, 250, 500, 750, 1000, 1500, 2000, 2500, 3000, 3500, 4000, 4500 or about 5000 psi. These values can also be used to define a range of values, such as about 100 to about 2500 psi. The temperature values can be greater than about 0, 5, 10, 15, 20, 25, 30, 35, 40, 45, 50, 55, 60, 65, 70, 75, 80, 85 or about 90 degrees Celsius. These values can also be used to define a range, such as about ambient to about 90 degrees Celsius, or about 15 to about 80 degrees Celsius. The temperature drop across the column can be greater than about 1, 2, 3, 4, 5, 6, 7, 8, 9 or about 10 degrees Celsius. These values can also be used to define a range, such as about 1 to about 5 degrees Celsius.

Using these parameters and the equations in the present disclosure, the total energy of the first system is calculated. The total energy of the first system can be greater than about 100, 120, 140, 160, 180, 200, 220, 240, 260, 280, 300, 320, 340, 360, 380, 400, 420, 440, 460, 480 or about 500 kJ/kg. These values can also be used to define a range, such as about 280 to about 400 kJ/kg. The following parameters from the second system are determined: P1, P2, T2, energy, etc. (See above for representative values). Using these parameters and the equations in the present disclosure, the total power needed to be added to the second system to obtain a corresponding total energy value consistent with the first system is calculated. The test solution components separated on the second system exhibit substantially similar separation performance as the first system. The absolute difference in total energy value of the second system compared to the first system can be less than about 20%, 18%, 16%, 14%, 12%, 10%, 8%, 7%, 6%, 5%, 4%, 3%, 2%, or about 1%. These values can also be used to define a range, such as about 1 and about 5%.

While this disclosure has been particularly shown and described with reference to example embodiments thereof, it will be understood by those skilled in the art that various changes in form and details may be made therein without departing from the scope of the invention encompassed by the appended claims.

What is claimed is:

1. A method of optimizing a separation in a carbon dioxide based chromatographic system having a pump, a carbon dioxide based mobile phase, a chromatographic column downstream of the pump, and a detector downstream of the column, wherein the column has an inlet and an outlet, the method comprising:
(a) measuring an inlet pressure and an inlet temperature of a mobile phase entering the column inlet and an outlet pressure of the mobile phase exiting the column outlet;
(b) calculating an average enthalpy of the mobile phase in the column;
(c) comparing the average enthalpy with a desired enthalpy value;
(d) adjusting the inlet pressure of the mobile phase entering the column inlet, the inlet temperature of the mobile phase entering the column inlet, or a combination of both to obtain the desired enthalpy value.

2. The method of claim 1, wherein the chromatographic column is a preparative, analytical or micro-analytical column.

3. The method of claim 1, wherein the inlet pressure is adjusted to obtain the desired enthalpy value.

4. The method of claim 1, wherein the inlet temperature is adjusted to obtain the desired enthalpy value.

5. The method of claim 1, wherein the inlet temperature is adjusted by a mobile phase pre-column heater to obtain the desired enthalpy value.

6. A method of efficiently transferring a carbon dioxide based separation between at least two different carbon dioxide based separation systems comprising:
(a) determining an average mobile phase enthalpy for a first carbon dioxide based separation on a first carbon dioxide based separation system; and
(b) performing a second carbon dioxide based separation on the second carbon dioxide based separation system at the average mobile phase enthalpy.

7. The method of claim 6, wherein the first separation system includes a first separation column and the second separation system includes a second separation column, wherein the first and the second columns have similar stationary phases.

8. The method of claim 6, wherein the first column has at least one different column dimension from the second column.

9. The method of claim 6, wherein the first column has a different particle size from the second column.

10. The method of claim 6, wherein the second carbon dioxide based separation performed on the second system exhibits substantially the same retention factor (k′) or selectivity as the first carbon dioxide based separation on the first system.

11. A method of transferring a carbon dioxide based separation procedure from a first system to a second system without re-optimizing the separation procedure conditions of the second system, comprising operating both systems at the same average mobile phase enthalpy value.
